(19) United States
(12) Patent Application Publication
(10) Pub. No.: US 2015/0161858 A1
(43) Pub. Date: Jun. 11, 2015

(54) SPEED DISPLAY DEVICE BY USING SATELLITE POSITIONING FUNCTION

(71) Applicant: MING CHUAN UNIVERSITY, TAIPEI (TW)

(72) Inventors: TA-YU FU, TAIPEI (TW); YUN-CHENG HSU, TAIPEI (TW); JUI-MING CHANG, TAIPEI (TW); KAI-CHIN CHOU, TAIPEI (TW)

(73) Assignee: MING CHUAN UNIVERSITY, TAIPEI (TW)

(21) Appl. No.: 14/186,104

(22) Filed: Feb. 21, 2014

(30) Foreign Application Priority Data
Dec. 10, 2013 (TW) 102223132

(51) Int. Cl. G08B 5/36

(52) U.S. Cl. CPC G08B 5/36

(57) ABSTRACT

A speed display device includes a wearing unit to which a display unit is connected. The display unit has a lighting module. A satellite positioning unit is connected to the wearing unit and the display unit. The satellite positioning unit has a processing module which is wirelessly connected with a global satellite system and receives at least one position-time signal of the wearing unit from the global satellite system. The processing module calculates a movement speed of the wearing unit according to the at least one position-time signal, and the movement speed is displayed by the lighting module. The drivers behind the wearer are acknowledged the clear and precise speed information to avoid from making a wrong judgment.

### BACKGROUND OF THE INVENTION

1. Fields of the invention

The present invention relates to a speed display device, and more particularly, to a speed display device by using satellite positioning function to display the speed of a wearing unit.

2. Descriptions of Related Art

Cycling and jogging are popular exercises and recreational activities, however, the cyclists and joggers have a potential risk on the roads from the following vehicles. The drivers of the following vehicles behind the cyclists and joggers have difficulty to acknowledge the speed that the cyclists and joggers move, especially in the dark areas. When the vehicles move fast, they may not be able to stop in time and tragedy happens.

The conventional warning or safety device the cyclists and joggers are usually connected to the bicycle frames or the clothes and can generate constant light or flashing light or reflect the light beams from the headlight to provide warning signal to the drivers of the following vehicles. Nevertheless, theses conventional warning or safety devices can only provide the position that the cyclists and joggers are located, the actual movement speed of the cyclists and joggers is not provided. The drivers behind still cannot judge the actual speed of the cyclists and joggers so that the cyclists and joggers may be hit by the vehicles, especially in dark areas. Besides, this problem can happen between the cyclists and joggers when they move as a group. The actual distance between the bicycles and joggers may not be precisely judged and multiple bicycles and joggers may be affected by one wrong judgment.

The present invention intends to provide a speed display device by using satellite positioning function to display the speed of a wearing unit on the cyclist or jogger to improve the shortcomings mentioned above.

### SUMMARY OF THE INVENTION

The present invention relates to a speed display device and comprises a wearing unit to which a display unit is connected. The display unit has a lighting module. A satellite positioning unit is connected to the wearing unit and the display unit. The satellite positioning unit has a processing module which is wirelessly connected with a global satellite system and receives at least one position-time signal of the wearing unit from the global satellite system. The processing module calculates a movement speed of the wearing unit according to the at least one position-time signal, and the movement speed is displayed by the lighting module.

Preferably, the display unit comprises a receiving module and the satellite positioning unit has a transmission unit which sends information of the movement speed to the receiving module.

Preferably, the display unit comprises a power module which is connected with the lighting module.

Preferably, the display unit comprises a power module which is connected with the lighting module and the receiving module.

Preferably, the wearing unit is a piece of cloth, a vest, a backpack or a helmet.

Preferably, the lighting module generates a constant light, a flashing light or a sequential light.

Preferably, the lighting module is made by electroluminescent wire or a Light Emitting Diode display members.

The primary object of the present invention is to provide a speed display device by using satellite positioning function to display the speed of a wearing unit. The speed is clearly and precisely displayed on the display unit on the wearing unit so that the drivers behind the wearer are acknowledged to avoid from making a wrong judgment.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the block diagram of the speed display device of the present invention;

FIG. 2 shows another embodiment of the block diagram of the speed display device of the present invention;

FIG. 3 shows the positioning status of the wearing unit of the speed display device of the present invention;

FIG. 4 shows a jogger equipped with the speed display device of the present invention;

FIG. 5 shows a cyclist equipped with the speed display device of the present invention;

FIG. 6 shows a backpack equipped with the speed display device of the present invention, and

FIG. 7 shows a helmet equipped with the speed display device of the present invention.

### DETAILED DESCRIPTION OF THE PREFERRED EMBODIMENT

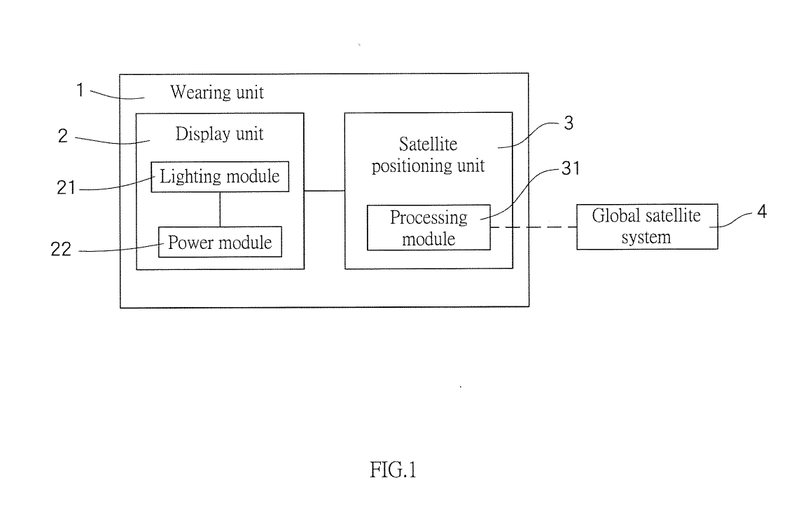

Referring to FIG. 1, the speed display device of the present invention comprises a wearing unit 1, a display unit 2 and a satellite positioning unit 3. The display unit 2 is connected to the wearing unit 1, and comprises a lighting module 21 and a power module 22. The lighting module 21 is made by cold-light material or Light Emitting Diode display members. The lighting module 21 generates a constant light, a flashing light or a sequential light. The power module 22 provides electric power to the lighting module 21.

The satellite positioning unit 3 is connected to the wearing unit 1 and the display unit 2. The satellite positioning unit 3 is connected to the display unit 2 by wires or wireless connection. FIG. 1 shows that the satellite positioning unit 3 is connected to the display unit 2 by wires. Preferably, the satellite positioning unit 3 is established in the wearing unit 1. The satellite positioning unit 3 has a processing module 31 which is wirelessly connected with a global satellite system 4 and receives at least one position-time signal of the wearing unit 1 from the global satellite system 4.

The processing module 31 calculates the movement speed of the wearing unit 1 according to the at least one position-time signal. The movement speed is then displayed by the lighting module 21.

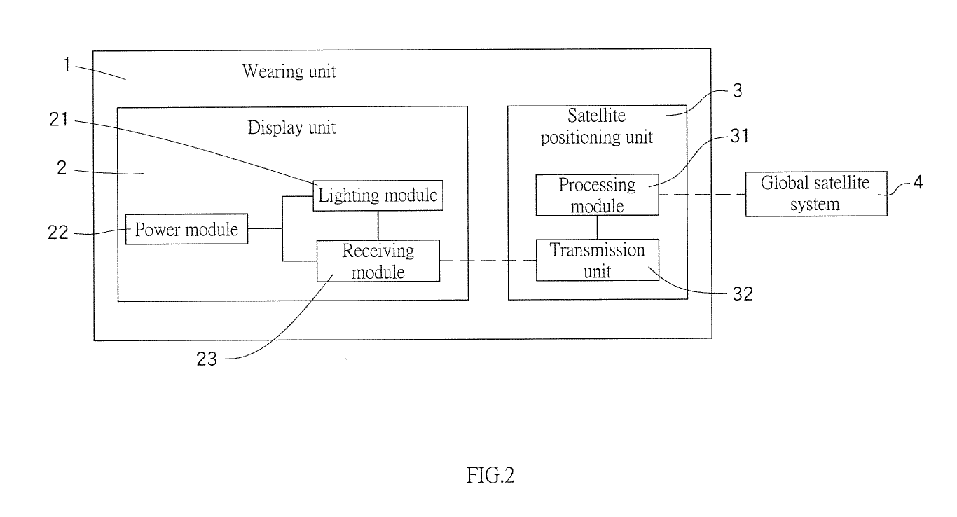

As shown in FIG. 2, the satellite positioning unit 3 is connected to the display unit 2 wirelessly. The display unit 2 comprises a receiving module 23. The satellite positioning unit 3 has a transmission unit 32 which sends information of the movement speed to the receiving module 23. The power module 22 is connected with the lighting module 21 and the receiving module 23. The satellite positioning unit 3 can be an individual unit which can be removed from the wearing unit 1 so that the satellite positioning unit 3 and the wearing unit 1 can be installed to different positions on the user's body. The communication between the transmission unit 32 and the receiving module 23 can be wireless or by way of Bluetooth.

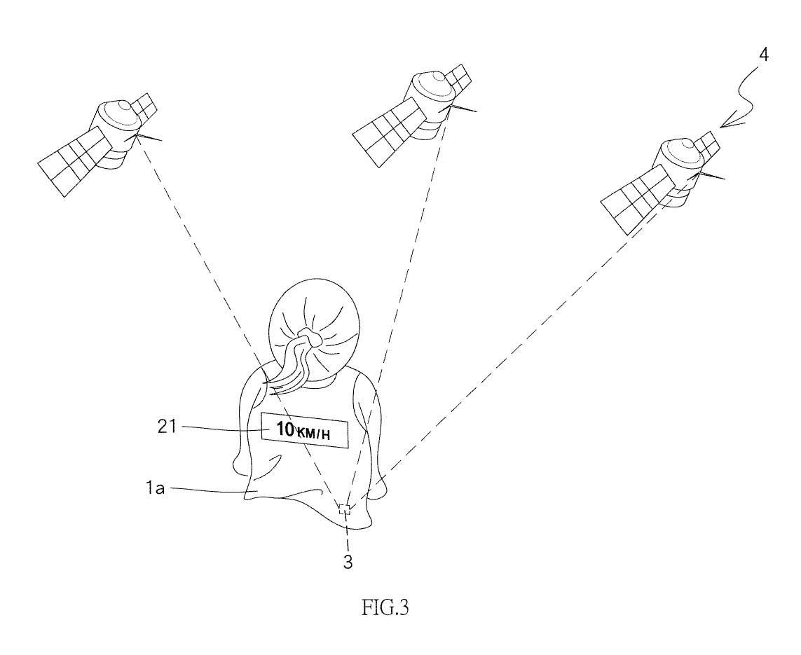

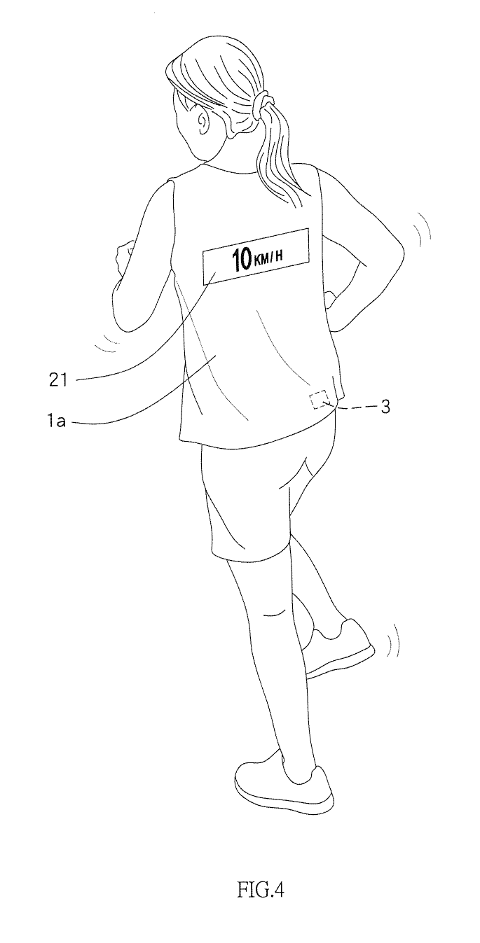

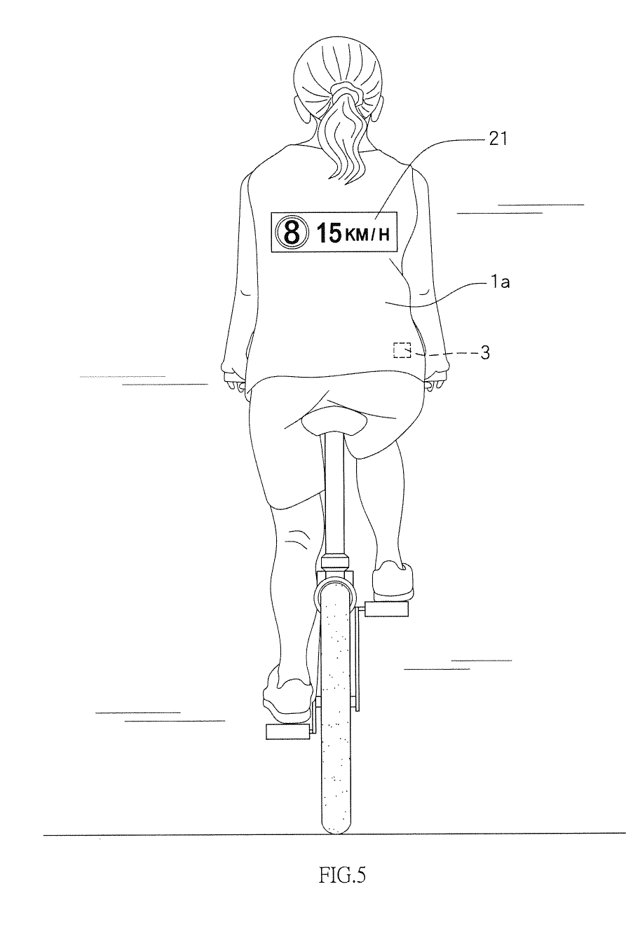

As shown in FIGS. 3 to 5, the wearing unit 1 is a vest 1a which is equipped with the satellite positioning unit 3, and when the jogger wears the wearing unit 1 as shown in FIG. 4, the satellite positioning unit 3 communicates the global satellite system 4 and receives signals from the global satellite system 4. The signals comprises the position-time signals in three-dimension form. The processing unit 31 processes the position-time signals to calculate the movement speed of the wearing unit 1 so as to obtain the distance and the speed that the jogger moves, By the wired and the wireless communication, the lighting module 21 displays the speed. When the user is a cyclist and wears the wearing unit 1 as shown in FIG. 5, the speed can be displayed on the back of the cyclist. If there are multiple cyclists and move as a group, the lighting module 21 displays the number, words or patterns which represent the number in the team. For example, the cyclist as shown in number 8 in the team and the speed is also displayed. In the drawing, the speed is shown by kilometers per hour.

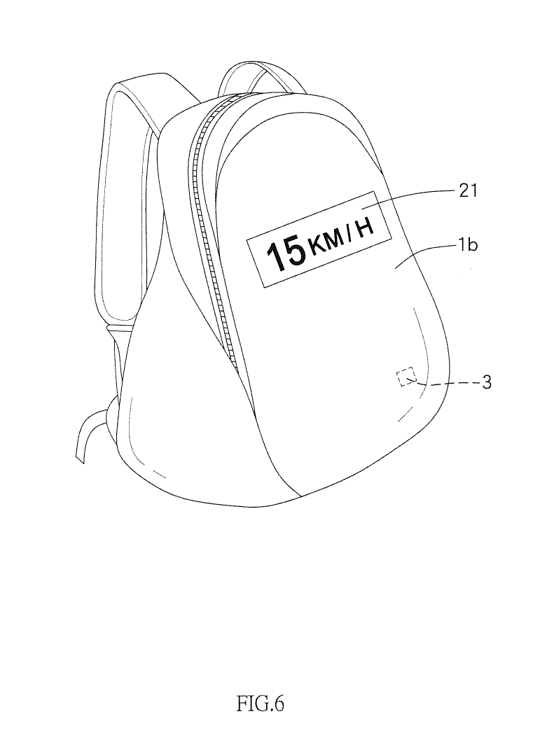

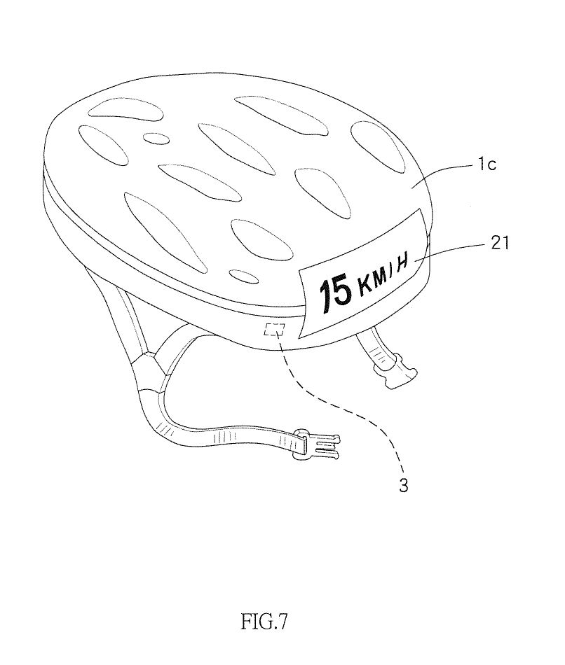

The second embodiment is shown in FIG. 6 and the difference from the previous embodiment is that the wearing unit 1 is a backpack 1b. FIG. 7 shows the third embodiment wherein the wearing unit 1 is a helmet 1c. In other words, the wearing unit 1 can be different items such as a piece of cloth, a vest 1a, a backpack 1b or a helmet 1c.

The present invention uses the satellite positioning unit 3 and the display unit 2 to display the necessary information on wearing unit 1 which can be a piece of cloth, a vest 1a, a backpack 1b or a helmet 1c. The display unit 2 is located on the back of the wearer. The wearing unit 1 has an independent satellite positioning unit 3 built therein which communicates with the global satellite system 4 so as to receive at least one position-time signal of the wearing unit 1. The processing unit 31 processes the position-time signals to calculate the movement speed of the wearing unit 1, and the lighting module 21 displays the speed. The drivers of the following vehicles are clearly acknowledged the actual speed and status of the wearers so as to keep a safe distance from the wearers to increase the road safety.

While we have shown and described the embodiment in accordance with the present invention, it should be clear to those skilled in the art that further embodiments may be made without departing from the scope of the present invention.

What is claimed is:

1. A speed display device comprising:
a wearing unit;
a display unit connected to the wearing unit and having a lighting module, and
a satellite positioning unit connected to the wearing unit and the display unit, the satellite positioning unit having a processing module which is wirelessly connected with a global satellite system and receives at least one position-time signal of the wearing unit from the global satellite system, the processing module calculating a movement speed of the wearing unit according to the at least one position-time signal, the movement speed being displayed by the lighting module.

2. The device as claimed in claim 1, wherein the display unit comprises a receiving module, the satellite positioning unit has a transmission unit which sends information of the movement speed to the receiving module.

3. The device as claimed in claim 1, wherein the display unit comprises a power module which is connected with the lighting module.

4. The device as claimed in claim 2, wherein the display unit comprises a power module which is connected with the lighting module and the receiving module.

5. The device as claimed in claim 1, wherein the wearing unit is a piece of cloth, a vest, a backpack or a helmet.

6. The device as claimed in claim 1, wherein the lighting module generates a constant light, a flashing light or a sequential light.

7. The device as claimed in claim 1, wherein the lighting module is made by electroluminescent wire or Light Emitting Diode display members.
